(19) United States
(12) Patent Application Publication
(10) Pub. No.: US 2024/0070277 A1
(43) Pub. Date: Feb. 29, 2024

(54) CLOUD-BASED UPDATING OF ROOT FILE SYSTEMS USING SYSTEM PARTITIONING

(71) Applicant: NVIDIA Corporation, Santa Clara, CA (US)

(72) Inventors: Li Ge, San Jose, CA (US); Nivedita Viswanath, San Jose, CA (US); Philip Rogers, Austin, TX (US); Rajat Chopra, Santa Clara, CA (US); Satish Salagame, Sunnyvale, CA (US)

(21) Appl. No.: 18/064,480

(22) Filed: Dec. 12, 2022

Related U.S. Application Data
(60) Provisional application No. 63/400,354, filed on Aug. 23, 2022.

(51) Int. Cl. G06F 21/57; G06F 21/60

(52) U.S. Cl. CPC G06F 21/57; G06F 21/602

(57) ABSTRACT

In various examples, systems for performing cloud-based updating of operating systems (e.g., root file systems) using system partitioning. For instance, a system(s) may initiate updates of the operating systems of machines, where the machines use system partitioning for the updating. More specifically, the system(s) may cause a machine to update the operating system using a standby system partition while the machine is currently running on another, active system partition. In some circumstances, the system(s) may perform these processes in order to update a cluster of machines, such as during a specific time period or at a certain frequency. By using such processes, the cluster of machines may still operate during the updating of the machines and/or even if the update fails on one or more of the machines.

### CROSS-REFERENCE TO RELATED APPLICATIONS

This application claims the benefit of U.S. Provisional Application No. 63/400,354, filed on Aug. 23, 2022, which is hereby incorporated by reference in its entirety.

### BACKGROUND

Traditional systems use package-based OS installations to update systems in multiple steps. For instance, during a package-based OS installation, a system resolves versions of the packages and executes the install commands at different steps, where failures to the updates may occur at any one of the updating steps. In some circumstances, when a failure occurs, the system may be unable to operate until the updates are correctly reinstalled on the system. Additionally, when updating a cluster of systems using package-based OS installations, if one of the systems fails to update, then the entire cluster of systems may fail to operate properly until the respective update is correctly installed on each system. This is further complicated when updates need to be initiated and/or controlled remotely, or otherwise where physical access to the system being updated is not available or practical. This may cause problems for users and/or devices that rely on accessing and/or utilizing the systems for performing tasks.

### SUMMARY

Embodiments of the present disclosure relate to cloud-based updating of root file systems using system partitioning. For instance, a cloud-based system(s) (hereinafter “system(s)”) may initiate updates of operating systems (e.g., the root file systems) of machines, where the machines use system partitioning (e.g., A/B partitioning) for the updating. More specifically, the system(s) may cause a machine to update the operating system (OS) using a standby system partition while the machine is currently running on another, active system partition. Once the installation is complete, the machine may then (1) reboot into the updated system partition using the updated version of the OS if the update was successful or (2) reboot back into the active system partition using the previous version of the OS if the update was unsuccessful. Additionally, the system(s) may perform these processes to update a cluster of machines, such as during a specific time period or at a certain frequency. As described herein, the time period may include, but is not limited to, at a predetermined minute, hour, day, and/or any other increment of time; and example update frequencies may include an update every x number of minutes, hours, days, or other unit of time.

In contrast to the conventional systems described herein, system(s) in accordance with embodiments of the present disclosure allow a user(s) and/or a device(s) to access the machine(s) even when the machine(s) is being updated. This is because the machine(s) uses an activate system partition to operate while the update is being performed on the standby system partition. Additionally, even if an update(s) associated with a machine(s) fails, the machine(s) and/or the cluster of machines is still able to operate by rebooting back to the active system partition(s) that uses the previous version of the OS. Because of this, the user(s) and/or the device(s) is still able to access the machine(s) and/or the cluster of machines even when the machine(s) is attempting to reinstall the update(s) after failure.

### BRIEF DESCRIPTION OF THE DRAWINGS

The present systems and methods for cloud-based updating of root file systems using system partitioning are described in detail below with reference to the attached drawing figures, wherein:

FIG. 1 is an example environment for which cloud-based updating of root file systems using system partitioning may be performed, in accordance with some embodiments of the present disclosure;

FIG. 2 illustrates an example flow diagram for a process of updating a machine using system partitioning, in accordance with some examples of the present disclosure;

FIG. 3 illustrates an example of how a cluster of machines may operate after one of the machines fails to update, in accordance with some examples of the present disclosure;

FIG. 4 is a flow diagram showing a method for updating a cluster of machines using system partitioning, in accordance with some embodiments of the present disclosure;

FIG. 5 is a flow diagram showing a method for updating a machine using system partitioning, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to cloud-based updating of root file systems using system partitioning. For instance, a system(s) may initially build an OS image that includes the updated root file system for a machine. In some examples, the system(s) builds the OS image offline. In some examples, such as when the system(s) is updating a cluster of machines, the system(s) builds a respective OS image for each type of machine. The system(s) may then notify the machine(s) (e.g., each machine from the cluster of machines) about the updated OS image(s). In some examples, the system(s) notifies the machine(s) by generating and then storing a container image(s) associated with the OS image(s) in a docker that is accessible to the machine(s). In some examples, the system(s) notifies the machine(s) by generating and then sending, to the machine(s), data indicating that the OS image(s) is available. In any of these examples, the system(s) may then update the machine(s) using the OS image(s).

As described herein, the system(s) may update a machine using system partitioning, such as A/B partitioning. For instance, the machine may include at least two system partitions, such as a first root file system partition (e.g., system_a, which may also be referred to as the “first system partition”) and a second root file system partition (e.g., system_b, which may also be referred to as the “second system partition”). The machine may be running the first system partition that uses a current version of the OS and/or a current version of the root file system, where the system partition that the machine is currently running may also be referred to as the “active system partition.” As such, the machine may not be running the second system partition that uses a previous version of the OS and/or a previous version the root file system, where the system partition that the machine is not currently running may also be referred to as the “standby system partition.” As such, to update the machine, the updated OS (e.g., the updated root file system) may be downloaded and installed to the standby system partition, which includes the second system partition in this example. This way, and as described herein, the updating of the OS on the machine is not disruptive to a user(s) of the machine.

As an example of updating the machine, the machine may initially load the existing configurations into the environment. As such, the machine may inherit some or all existing installation configurations that are available for the rest of the steps of the updating process. The system(s) and/or the machine may then determine which of the system partitions is the active system partition and/or which of the system partitions is the standby system partition. For instance, and using the example above, the system(s) and/or the machine may determine that the first system partition is the active system partition and the second system partition is the standby system partition. In some examples, the system(s) and/or the machine may then perform one or more checks to verify that the machine (e.g., the partitioning system) is able to proceed with the update. For example, the system(s) and/or the machine may verify that the existing disk layout is suitable for the update, that a required mount point(s) is available, and/or perform one or more other checks.

The system(s) may then the send the OS image associated with the updated version of the OS (e.g., the updated root file system) to the machine. In some examples, to send the OS image, the machine may download the OS image from a datastore associated with the system(s). In some examples, the system(s) may authenticate the machine before the machine is able to download the OS image from the datastore. Additionally, in some examples, and as described in more detail below, the datastore may support verification of the OS image that is sent to the machine, such as by using one or more hashes and a key.

The machine may then write the OS image to the standby system partition, which again includes the second system partition in the examples described herein. The machine may then update the OS using the OS image. In some examples, the updating of the OS is initiated by the machine. For example, the OS that is running on the active system partition may trigger the post install script of the OS image on the standby system partition, where the post install script causes the updating of the OS. In some examples, the updating of the OS is initiated by the system(s). For example, the system(s) may send data to the machine, such as a command, that causes the machine to begin updating the OS using the OS image (e.g., the command may trigger the post install script). In such an example, the machine is updated automatically without user input.

For an example of the system(s) initiating the update, the system(s) may use an over the air (OTA) runner to perform the updating on the machine, where the OTA runner is a container that implements the system partitioning update flow. For instance, the OTA runner may include a job, where a job controller creates a pod(s) associated with the job. The pod(s) may include one or more permissions to perform the system update (e.g., the A/B system partitioning update) on the machine. The permission(s) may include, but is not limited to, a first permission to write to the standby system partition (e.g., the second system partition in the examples described herein) in order to install the updated OS, a permission to update the boot configuration, a permission to write to a data volume, a permission to call an operation (e.g., Chroot) that runs the post install script, a permission to setup pseudo file systems mounts in order to run the post install script, a permission to call the reboot once the installation is complete, and/or any other permission.

For example, the steps within OTA runner pod(s) may include, but are not limited to, (1) updating a configuration(s) using values in environmental variables as prescribed by the system(s), (2) updating a system configuration file(s) (e.g., etc/fstab File) based on the current disk partition layout, (3) updating a network configuration(s) (e.g., netplan) based on interface names configured during the OS installation, (4) updating an administrative user configuration(s) based on the administrative user configuration(s) from the OS installation, (5) installing systemsd services, (6) updating a temporary root file system (e.g., initrd, initramfs, etc.) so that the temporary root file system is able use one or more keys to unlock encrypted disk partitions, (7) installing a processing unit (e.g., GPU, etc.) driver, (8) installing a bootloader (e.g., GRUB) so that the bootloader is configured to boot from the updated root file system (with a fallback to boot from the current root file system if needed, as described herein), (9) updating one or more directories under a data volume(s) using the content of the updated root file system, and/or perform one or more additional and/or alternative processes. In some examples, after installation, the system(s) and/or the machine may then trigger a reboot to finish the update.

In some examples, the configurations, such as a machine configuration(s) and/or a clustering configuration(s), may be copied from the active system partition to the standby system partition. The machine configuration(s) may include, but is not limited to, the graphics configurations, the dynamic configurations, the network configurations, time configurations, and/or any other configuration. Additionally, such as when the machine is included within a cluster of machines, the machine may copy one or more clustering configurations from the active system partition to the standby system partition. The clustering configuration(s) may include, but is not limited to, configurations indicating the locations of the machines included in the cluster, configurations indicating how to connect with the machines included in the cluster, configurations indicating the types of the machines included in the cluster, and/or the like.

In some examples, such as when the update was successful, the machine may reboot using the updated partition, which may include the second system partition in examples described herein. As such, the second system partition may then include the active system partition while the first system partition includes the standby system partition. By updating the machine using such a process, and as described herein, the only downtime that the user(s) may experience is during the rebooting of the machine.

However, in some examples, the updating of the machine may fail based on one or more errors occurring. In some examples, an error(s) may include the OTA runner failing, such as by not starting (e.g., due to an error(s) in the image pull, an error(s) with the volume mount, etc.), not executing (e.g., due to an input/output error(s), a bug(s) in the runner script, etc.), and/or based on one or more additional and/or alternative errors with the OTA runner. In some examples, an error(s) may still occur even when the OTA runner succeeds, but the reboot of the machine fails, such as due to the updated root file system having one or more problems. While these are just a couple examples of errors that may occur when updating the machine, in other examples, the machine may fail to update based on one or more additional and/or alternative errors.

As described herein, even if the machine fails to update correctly, the machine may use one or more fallback operations to continue operating as intended. For example, the machine may reboot back into the active system partition, which includes the first system partition in the examples described above, if the update fails within the standby system partition. In some examples, the machine is able to reboot back into the active system partition since the update (e.g., the modification) occurred within the standby system partition and, as such, may not (e.g., will not) have affected the current version of the OS (e.g., the current version of the root file system) executing in the active system partition. In some examples, to reboot back into the active system partition, two entries may have been added to the bootloader, such as a first entry (e.g., Entry “A”) corresponding to the updated OS and a second entry (e.g., Entry “B”) corresponding to the previous OS. As such, the first entry may be set as the default entry for a single boot while the second entry is set as the default entry for all subsequent boots. Because of this, when the initial reboot is triggered, the first entry is selected, which causes the machine to attempt to reboot using the update system partition (e.g., the previous standby system partition). However, if there is a failure with the reboot, then another reboot is triggered and the second entry is selected, which causes the machine to boot using the active system partition.

It should be noted that, in such examples, if the initial reboot is successful, then the entry bootloader may be updated to use the first entry for all subsequent reboots. This way, the machine may boot into the updated system partition, which would then include the active system partition, for all subsequent boots.

In some examples, the machine may perform one or more processes based on the update failing. For a first example, the machine may generate data indicating that the update failed, indicating why the update failed, and/or including any other information associated with the update. The machine may then send the data to the system(s) so that the system(s) is able to determine that the update failed. For a second example, the machine may again perform the processes described herein to retry updating the OS on the standby system partition (e.g., the second system partition where the update initially failed). In some examples, the machine may perform the processes described herein to attempt to update the OS until the update is successful.

In some examples, and as described herein, the system(s) may perform similar processes to update the OS on more than one machine included in a cluster of machines. For example, one or more of the machines (e.g., each machine) within the cluster of machines may perform the processes described herein to update a respective OS associated with the machine(s). In some examples, different types of machines may use different OS images when updating. For instance, and as described above, the system(s) may generate a respective OS image for each type of machine, where the respective OS image is associated with a file(s), a program(s), and/or the like for the type of machine.

In examples where the system(s) update a cluster of machines, machines may perform different processes based on whether one or more of the updates failed on one or more of the machines. As a first example, if an update(s) fails on a machine(s) included in the cluster of machines, then one or more of the other machines (e.g., all of the other machines) may operate using the previous active system partition that was not updated, similar to the failed device. As a second example, and again if an update(s) fails on a machine(s) included in the cluster of machines, then a new cluster of machines may be created by removing the failed machine(s) from the cluster of machines. Still, as a third example, and again if an update(s) fails on a machine(s) included in the cluster of machines, the failed machine(s) may operate using the previous active system partition while another machine(s) included in the cluster of machines operates using the updated partition. While these are example processes may be performed when a machine(s) from a cluster of machines fails to update, in other examples, one or more additional and/or alternative processes may be performed.

In some examples, the system(s) and/or the machine may perform one or more processes to verify the authenticity of the machine, the update, and/or the updated OS (e.g., the updated root file system). For example, the system(s) may generate a key associated with the update (e.g., associated with the OS that is being installed on the machine). In some examples, the key may be associated with a time window such as, but not limited to, one second, ten seconds, one minute, five minutes, and/or any other time window. The system(s) may then send the key to verify the machine, such as part of the OS image and/or the updated root file system (e.g., the key may be embedded within the OS image and/or updated root file system). When the machine reboots using the updated OS and/or the updated root file system in the updated system partition, the machine may compute new hashes, such as based on the updated root file system, the variables, and/or using any other data. For example, the machine may generate a hash of the updated root file system, a hash of the variables, and/or any other hash.

The system(s) and/or the machine may then verify the update using the new hashes and the key, such as within the time window. In some examples, the machine may sign the hashes using the key and then send the signed hashes to the system(s). In some examples, the machine may send the key along with the hashes to the system(s). In either example, the system(s) may then determine whether to register the new hashes (and/or the variables associated with the new hashes) based on comparing the received hashes with the expected hashes and/or comparing the received key with the generated key. For a first example, the system(s) may determine not to register the new hashes when the received hashes do not match the expected hashes and/or the received key does not match the generated key. For a second examples, the system(s) may determine to register the new hashes when the received hashes match the expected hashes and/or the received key matches the generated key. Additionally, the system(s) may then allow the machine to override the previous hashes with the new hashes that the system(s) will then use when authenticating the machine.

In some examples, the system(s) and/or the machine may perform one or more additional processes to secure the OS on the machine. For instance, the updated root file system may be rendered immutable before and/or after update. In some examples, such as when the updated root file system is rendered immutable after the update, the system(s) and/or the machine may verify that the updated root file system has not been modified using the processes described herein, such as using one or more of the hashes.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

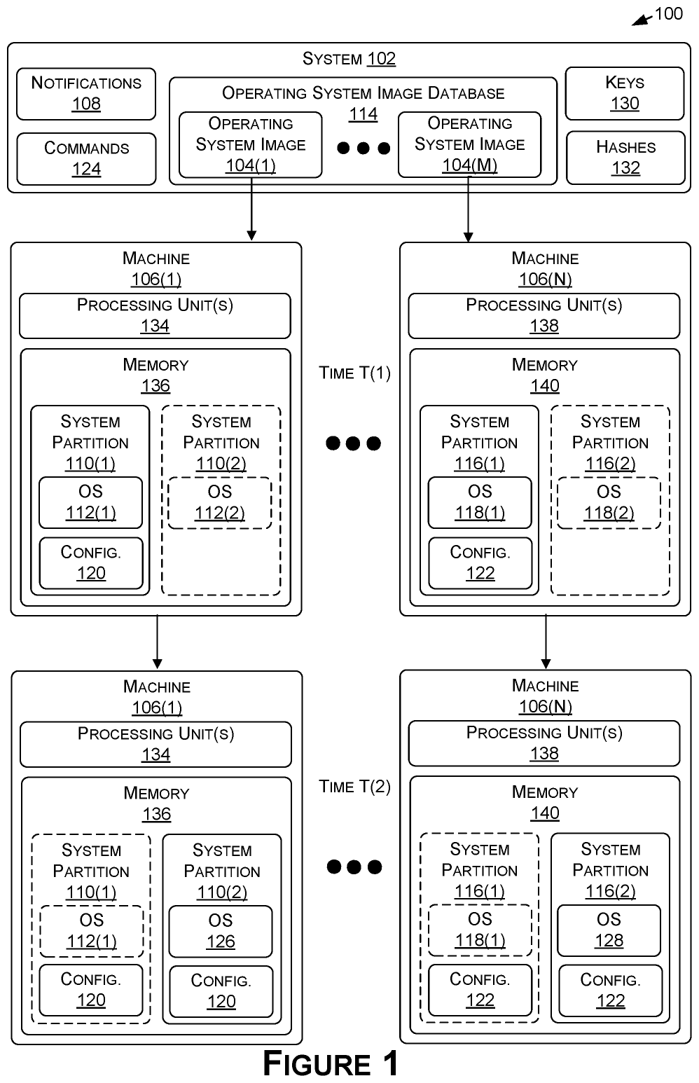

With reference to FIG. 1, FIG. 1 is an example environment for which cloud-based updating of root file systems using system partitioning may be performed, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown, a system(s) 102 may generate operating system (OS) images 104(1)-(N) (also referred to singularly as “OS image 104” or in plural as “OS images 104”) associated with updates for machines 106(1)-(N) (also referred to singularly as “machine 106” or in plural as “machines 106”). As described herein, a machine 106 may include, but is not limited to, a system, a server, a computing device, a mobile device, a vehicle (e.g., an autonomous vehicle, a semi-autonomous vehicle, etc.), a database, an edge device, and/or any other type of machine and/or device. In some examples, the machines 106 are included in a cluster of machines that work together to perform one or more tasks. When operating as a cluster, in some examples, the machines 106 may include a same type of machine, such as with similar hardware, similar software (e.g., OS), and/or configured to perform similar tasks. However, in other examples, the machines 106 may include different types of machines, such as with different hardware, different software, and/or configured to perform different tasks.

The system(s) 102 may be configured to generate the OS images 104 offline. In some examples, the system(s) may be configured to generate a respective OS image 104 for one or more (e.g., each) types of machines 106. For instance, and in the example of FIG. 1, the system(s) 102 may generate an OS image 104(1) for a first type of machine that is associated with the machine 106(1) and an OS image 104(M) for a second type of machine that is associated with the machine 106(N). For instance, the OS image 104(1) may be associated with an updated OS for the machine 106(1) that is generated based on the hardware of the machine 106(1), the software of the machine 106(1), the tasks that the machine 106(1) is configured to perform, and/or the like. Additionally, the OS image 104(M) may be associated with an updated OS for the machine 106(N) that is generated based on the hardware of the machine 106(N), the software of the machine 106(N), the tasks that the machine 106(N) is configured to perform, and/or the like.

The system(s) 102 may announce to the machines 106 (and/or a user(s) of the machines 106) that the updates are available. In some examples, to make the announcements, the system(s) 102 may push container images (represented in FIG. 1 as “notifications 108”), which may also be referred to as “release pointers,” into a specified docker repository. The machines 106 may then discover the updates by scraping the release pointers, such as by using sidecar containers. For example, a container (e.g., an EMS container) may create (or update) objects (e.g., update.egx objects) in each location by querying a sidecar graph application programming interface (API). In some examples, the objects specify the version for each machine 106 as well as the container images (e.g., Over-the-Air (OTA) runners) to use for updating.

A component (e.g., an Elastic Fabric Adapter (EFA)) running on the machines 106 may then monitor the objects, such as by using an API (e.g., an EMS API). Based on the monitoring, the machines 106 may discover the desired versions of the respective OS as well as instructions on how to perform the update (e.g., which OTA runner image to use, what are the command line arguments and/or environment variables to pass when launching the containers, etc.). The component may then create one or more jobs to run the container images based on the discovered configuration to perform the OTA update. In some examples, the component may further monitor the corresponding OTA runner pods and report their container status back to the system(s) 102 (e.g., back to the EMS).

As described herein, the system(s) 102 may update one or more of the machines 106 (e.g., each machine 106) using system partitioning, such as A/B partitioning. For instance, the machine 106(1) may include at least two system partitions, such as a first root file system partition 110(1) (e.g., system_a, which may also be referred to as the “first system partition 110(1)”) and a second root file system partition 110(2) (e.g., system_b, which may also be referred to as the “second system partition 110(2)”). At a first time T(1), which is represented by the top illustration of the machine 106(1), the machine 106(1) may be running the first system partition 110(1) that uses a current version of the OS 112(1) and/or a current version of the root file system, where the system partition that the machine 106(1) is currently running may also be referred to as the “active system partition” (which is also indicated by the solid line in the top illustration of the machine 106(1)). As such, the machine 106(1) may not be running the second system partition 110(2) that uses a previous version of the OS 112(2) and/or a previous version the root file system, where the system partition that the machine 106(1) is not currently running may also be referred to as the “standby system partition” (which is also indicated by the dashed line in the top illustration of the machine 106(1)). As such, to update the machine 106(1), the updated OS image 104(1) (e.g., the updated root file system) may be downloaded from an OS image database 114 and installed to the standby system partition, which includes the second system partition 110(2). This way, and as described herein, the updating of the OS and/or the root file system on the machine 106(1) is not disruptive to a user(s) of the machine 106(1).

Similarly, the machine 106(N) may include at least two system partitions, such as a first root file system partition 116(1) (e.g., system_a, which may also be referred to as the “first system partition 116(1)”) and a second root file system partition 116(2) (e.g., system_b, which may also be referred to as the “second system partition 116(2)”). At the first time T(1), which is represented by the top illustration of the machine 106(N), the machine 106(N) may be running the first system partition 116(1) that uses a current version of the OS 118(1) and/or a current version of the root file system, where the system partition that the machine 106(N) is currently running may also be referred to as the “active system partition” (which is also indicated by the solid line in the top illustration of the machine 106(N) in the example of FIG. 1). As such, the machine 106(N) may not be running the second system partition 116(2) that uses a previous version of the OS 118(2) and/or a previous version the root file system, where the system partition that the machine 106(N) is not currently running may also be referred to as the “standby system partition” (which is also indicate by the dashed line in the top illustration of the machine 106N) in the example of FIG. 1). As such, to update the machine 106(N), the updated OS image 104(M) (e.g., the updated root file system) may be downloaded and installed to the standby system partition, which includes the second system partition 116(2). This way, and as described herein, the updating of the OS and/or the root file system on the machine 106(N) is not disruptive to a user(s) of the machine 106(N).

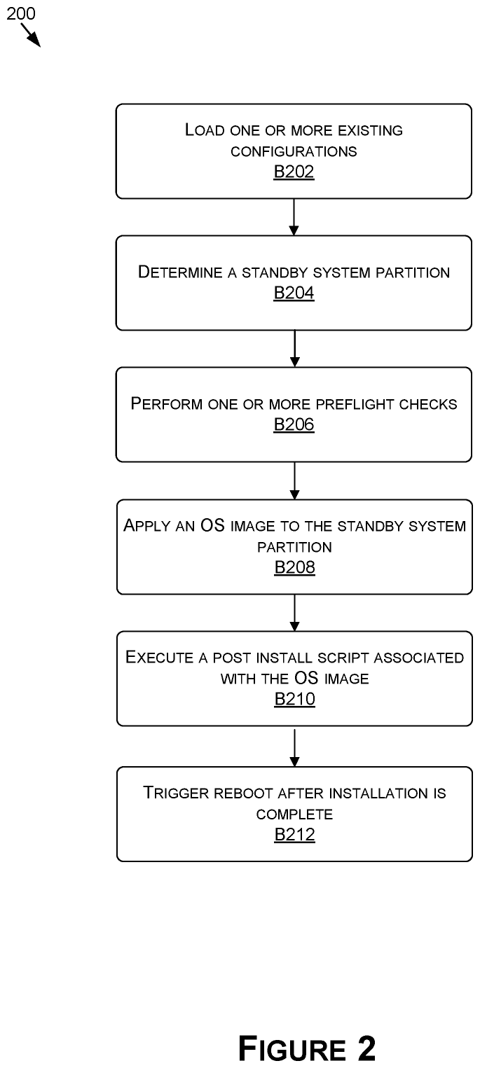

As an example of updating a machine 106, FIG. 2 illustrates an example flow diagram for a method 200 of updating a machine 106 using system partitioning, in accordance with some examples of the present disclosure. As shown, the method 200, at block B202, may include loading one or more existing configurations (e.g., configurations 120 of the machine 106(1) and/or configurations 122 of the machine 106(N). In some examples, the loading of the configuration(s) is so that the configuration(s) are available for one or more later steps of the method 200. As described herein, the configuration(s) may include, but is not limited to, the graphics configurations, the dynamic configurations, the network configurations, time configurations, and/or any other configuration. Additionally, such as when the machine 106 is included within a cluster of machines, the machine 106 may load one or more clustering configurations. The clustering configuration(s) may include, but is not limited to, configurations indicating the locations of the machines 106 included in the cluster, configurations indicating how to connect with the machines 106 included in the cluster, configurations indicating the types of the machines 106 in the cluster, and/or the like.

The method 200, at block B204, may include determining a standby system partition system. For instance, the system(s) 102 and/or the machine 106 may determine the current standby system partition, such as the second system partition 110(2) of the machine 106(1) or the second system partition 116(2) of the machine 106(N) at the first time T(1) in the example of FIG. 1. In some examples, the system(s) 102 and/or the machine 106 may also determine the current active system partition, such as the first system partition 110(1) of the machine 106(1) or the first system partition 116(1) of the machine 106(N) in the example of FIG. 1.

The method 200, at block B206, may include running one or more preflight checks. For instance, the system(s) 102 and/or the machine 106 may verify that the system partition updates are able to proceed. In some examples, to perform the verifications, the system(s) 102 and/or the machine 106 may check conditions such as whether the existing disk layout is suitable for the system partitioning update, whether required mount points are available, and/or perform one or more additional and/or alternative checks.

The method 200, at block B208, may include applying an OS image to the standby system partition system. For instance, and as described herein, the system(s) 102 may send the updated OS image 104 (e.g., the updated root file system) to the machine 106. In some examples, to send the updated OS image 104, the machine 106 may download the updated OS image 104 from the OS image database 114 (e.g., a datastore) associated with the system(s) 102. In some examples, the system(s) 102 may authenticate the machine 106 before the machine 106 is able to download the updated OS image 104 from the OS image database 114. Additionally, in some examples, and as described in more detail below, the OS image database 114 may support verification of the updated OS image 104 that is sent to the machine 106, such as by using one or more hashes and a key. The machine 106 may then write the updated OS image 104 to the standby system partition, such as the second system partition 110(1) of the machine 106(1) and the second system partition 116(2) of the machine 106(N) at the first time T(1) in the example of FIG. 1.

The method 200, at block B210, may include executing a post install script associated with the OS image. For instance, the machine 106 may then update the OS (and/or the root file system) using the updated OS image 104. In some examples, updating of the OS is initiated by the machine 106. For example, the OS that is running on the active system partition (the OS 112(1) executing on the first system partition 110(1) of the machine 106(1) and/or the OS 118(1) executing on the first system partition 116(1) of the machine 106(N)) may trigger the post install script on the standby system partition, where the post install script causes the updating of the OS. In some examples, the updating of the OS may be initiated by the system(s) 102. For example, the system(s) 102 may send data to the machine 106, such as a command 124, that causes the machine 106 to begin updating the OS using the OS image 104 (e.g., triggers a post install script). This way, the machine 106 is updated automatically without user input.

For an example of the system(s) 102 initiating the update, the system(s) 102 may use a OTA runner to perform the updating on the machine 106. As described herein, the OTA runner may include a container that implements the system partitioning update flow. For instance, the OTA runner may include a job, where a job controller creates one or more pod associated with the job. The pod(s) may include one or more permissions to perform the system partitioning update on the machine 106. The permission(s) may include, but is not limited to, a first permission to write to the standby system partition (e.g., the second system partition 110(2) of the machine 106(1) and the second system partition 116(2) of the machine 106(N) at the first time T(1) in the example of FIG. 1) in order to install the updated OS, a permission to update the boot configuration, a permission to write to a data volume, a permission to call an operation (e.g., Chroot) that runs the post install script, a permission to setup pseudo file systems mounts in order to run the post install script, a permission to call the reboot once the installation is complete, and/or any other permission.

For example, the steps within an OTA runner pod(s) may include, but are not limited to, (1) updating a configuration(s) using values in environmental variables as prescribed by the system(s) 102, (2) updating a system configuration file(s) (e.g., etc/fstab File) based on the current disk partition layout, (3) updating a network configuration(s) (e.g., netplan) based on interface names configured during the OS installation, (4) updating an administrative user configuration(s) based on the administrative user configuration(s) from the OS installation, (5) installing systemsd services, (6) updating a temporary root file system (e.g., initrd, initramfs, etc.) so that the temporary root file system is able use one or more keys to unlock encrypted disk partitions, (7) installing a processing unit (e.g., GPU, etc.) driver, (8) installing a bootloader (GRUB) so that the bootloader is configured to boot from the updated root file system (with a fallback to boot from the current root file system if needed, as described herein), (9) updating one or more directories under a data volume(s) using the content of the updated root file system, and/or performing one or more additional and/or alternative processes.

The method 200, at block B212, may include triggering a reboot after installation is complete. For instance, after installation, the system(s) 102 and/or the machine 106 may trigger a reboot in order to finish the update. In some examples, such as when the update was successful, the machine 106 may reboot using the updated partition. By updating the machine 106 using such a process, and as described herein, the only downtown that the user(s) may experience is during the rebooting of the machine 106.

For instance, and referring back to the example of FIG. 1, the bottom illustration of the machines 106 may be associated with the machines 106 at a second time T(2) after updating. As shown, the second system partition 110(2) of the machine 106(1) may include the active system partition, which is indicated by the solid line. The second system partition 110(2) includes an updated OS 126 (and/or updated root file system) associated with the OS image 104(1) and the configurations 120 copied over from the first system partition 110(1). The first system partition 110(1) also includes the standby system partition that includes the previous version of the OS 112(1), which is indicated by the dashed lines. Additionally, and as also shown, the system second partition 116(2) of the machine 106(N) may include the active system partition, which is indicated by the solid line. The second system partition 116(2) includes an updated OS 128 (and/or updated root file system) associated with the OS image 104(M) and the configurations 122 copied over from the first system partition 116(1). The first system partition 116(1) also includes the standby system partition that includes the previous version of the OS 118(1), which is indicated by the dashed lines.

As described herein, in some examples, the system(s) 102 and/or the machines 106 may perform one or more processes to verify the authenticity of the machines 106, the updated OS, and/or the updated root file system. For example, and for the machine 106(1), the system(s) 102 may generate a key 130 associated with the update (e.g., associated with the updated OS 126 that is being installed on the machine 106(1)). In some examples, the key 130 may be associated with a time window such as, but not limited to: one second, ten seconds, one minute, five minutes, and/or any other time window. The system(s) 102 may then send the key 130 to verify the machine 106(1), such as part of the updated OS 126 and/or the updated root file system (e.g., the key 130 may be embedded within the OS image 104(1) and/or updated root file system). For instance, when the machine 106(1) reboots using the updated OS 126 and/or the updated root file system in the updated system partition 110(2), the machine 106(1) may compute new hashes 132, such as based on the updated root file system, the variables, and/or using any other data. For example, the machine 106(1) may generate a hash 132 of the updated root file system, a hash 132 of the variables, and/or any other hash 132.

The system(s) 102 and/or the machine 106(1) may then verify the update using the new hashes 132 and the key 130, such as within the time window. In some examples, the machine 106(1) may sign the hashes 132 using the key 130 and then send the signed hashes 132 to the system(s) 102. In some examples, the machine 106(1) may send the key 130 along with the hashes 132 to the system(s) 102. In either example, the system(s) 102 may then determine whether to register the new hashes 132 (and/or the variables associated with the new hashes 132) based on comparing the received hashes 132 with the expected hashes 132 and/or comparing the received key 130 with the generated key 130. For a first example, the system(s) 102 may determine not to register the new hashes 132 when the received hashes 132 do not match the expected hashes 132 and/or the received key 130 does not match the generated key 130. For a second example, the system(s) 102 may determine to register the new hashes 132 when the received hashes 132 match the expected hashes 132 and/or the received key 130 matches the generated key 130. Additionally, the system(s) 102 may then allow the machine 106(s) to override the previous hashes 132 with the new hashes 132 that the system(s) 102 will then use when authenticating the machine 106(1).

In some examples, the system(s) 102 and/or the machine 106(1) may perform one or more additional processes to secure the OS 126 on the machine 106(1). For instance, the updated OS 126 and/or the updated root file system may be rendered immutable before and/or after the update. In some examples, such as when the updated OS 126 and/or the updated root file system is rendered immutable after the update, the system(s) 102 and/or the machine 106(1) may verify that the updated OS 126 and/or the updated root file system has not been modified using the processes described herein, such as using one or more of the hashes 132.

While the examples above describe the attempts to update the machines 106 being successful, in some examples, an attempt to update one or more of the machines 106 may fail based on one or more errors occurring. In some examples, an error(s) may include the OTA runner failing, such as by not starting (e.g., due to an error(s) in the image pull, an error(s) with the volume mount, etc.), not executing (e.g., due to an input/output error(s), a bug(s) in the runner script, etc.), and/or based on one or more additional and/or alternative errors with the OTA runner. In some examples, an error(s) may still occur even when the OTA runner succeeds, but the reboot of the machine 106 fails, such as due to the updated root file system having one or more problems. While these are just a couple examples of errors that may occur when updating the machines 106, in other examples, the machines 106 may fail to update based on one or more additional and/or alternative errors.

As described herein, even if an attempt to update a machine 106 fails to be completed, the machine 106 may use one or more fallback operations in order to continue operating as intended. For example, the machine 106 may reboot back into the initial active system partition, which includes the first system partition 110(1) of the machine 106(1) and/or the first system partition 116(1) of the machine 106(N) at the first time T(1) in the example of FIG. 1, if the update fails within the standby system partition. In some examples, the machine 106 is able to reboot back into the active system partition since the update (e.g., the modification) occurred within the standby system partition and, as such, may not have affected the current version of the OS (e.g., the OS 112(1) of the machine 106(1) and/or the OS 118(1) of the machine 106(N)) executing in the active system partition.

In some examples, to reboot back into the active system partition, two entries may have been added to the bootloader, such as a first entry (e.g., Entry “A”) corresponding to the updated root file system and a second entry (e.g., Entry “B”) corresponding to the previous root file system. As such, the first entry may be set as the default entry for a single boot while the second entry is set as the default entry for all subsequent boots. Because of this, when the initial reboot is triggered, the first entry is selected, which causes the machine 106 to attempt to reboot using the update system partition (e.g., the previous standby system partition). However, if there is a failure with the reboot, then another reboot is triggered, where the second entry is selected which causes the machine 106 to boot using the active system partition.

It should be noted that, in such examples, if the initial reboot is successful, then the entry bootloader may be updated to use the first entry for all subsequent reboots. This way, the machine 106 may boot into the updated system partition, which would then include the active system partition, for all subsequent boots.

In some examples, the machine 106 may perform one or more processes based on the update failing. For a first example, the machine 106 may generate data indicating that the update failed, indicating why the update failed, and/or including any other information associated with the update. The machine 106 may then send the data to the system(s) 102 so that the system(s) 102 is able to determine that the update failed. For a second example, the machine 106 may again perform the processes described herein to retry updating the OS on the standby system partition (e.g., the system partition where the update initially failed). In some examples, the machine 106 may perform the processes described herein to attempt to update the OS until the update is successful.

In some examples, and as described herein, the system(s) 102 may perform similar processes to update the OS on more than one machine 106 included in a cluster of machines. For example, one or more of the machines 106 (e.g., each machine 106) within the cluster of machines may perform one or more processes described herein to update a respective OS associated with the machine 106. In some examples, different types of machines 106 may use different OS images 104 when updating. For instance, and as described above, the system(s) 102 may generate a respective OS image 104 for each type of machine 106, where the respective OS image 104 is associated with a file(s), a program(s), and/or the like for the type of machine 106.

In examples where the system(s) 102 update a cluster of machines, the machines 106 may perform different processes based on whether one or more of the updates failed on one or more of the machines 106. For a first example, if an update(s) fails on a machine(s) 106 included in the cluster of machines, then one or more of the other machines 106 (e.g., all of the other machines 106) may operate using the previous active system partition that was not updated, similar to the failed machine 106. For a second example, and again if an attempt to update fails on a machine(s) 106 included in the cluster of machines, then a new cluster of machines may be created by removing the failed machine(s) 106 from the cluster of machines. Still, for a third example, and again if an attempted update(s) fails on a machine(s) 106 included in the cluster of machines, the failed machine(s) 106 may operate using the previous active system partition while another machine(s) 106 included in the cluster of machines operates using the update system partition. While these are just a few example processes that may be performed when a machine(s) 106 from a cluster of machines fails to update, in other examples, one or more additional and/or alternative processes may be performed.

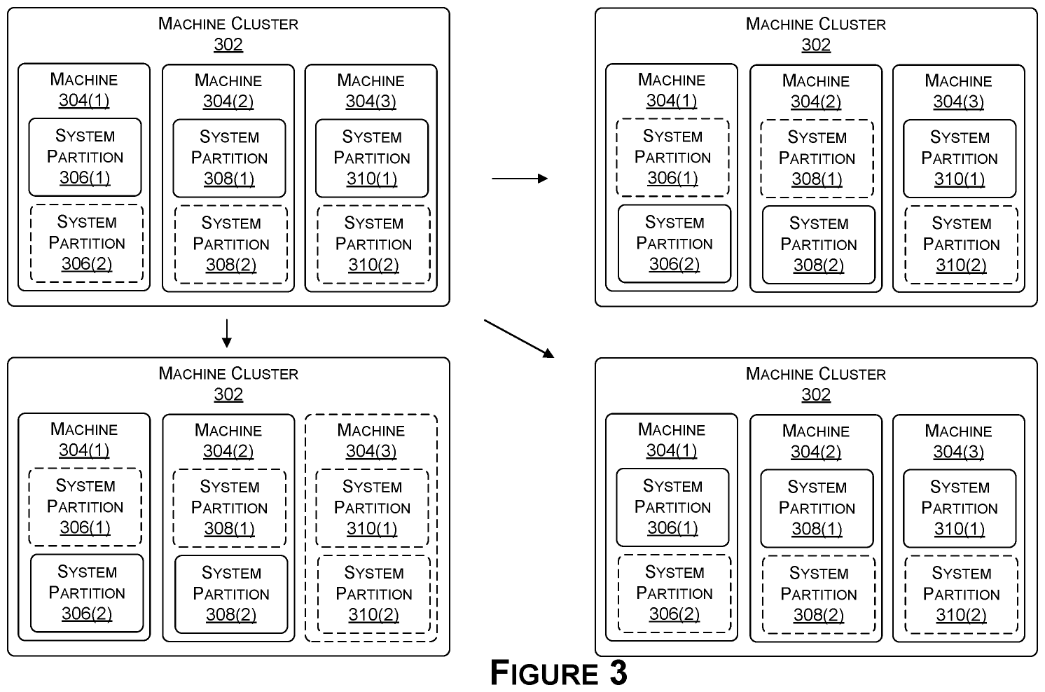

For instance, FIG. 3 illustrates an example of how a cluster of machines 302 may operate after one of the machines fails to update, in accordance with some examples of the present disclosure. As shown, the cluster of machines 302 may include three machines 304(1)-(3) (also referred to singularly as “machine 304” or in plural as “machines 304”), however, in other examples, the cluster of machines 302 may include any other number of machines 304. At a time prior to updating the cluster of machines 302, which is show by the upper-left illustration, a first system partition 306(1) of the first machine 304(1), a first system partition 308(1) of the second machine 304(2), and a first system partition 310(1) of the third machine 304(3) may include active system partitions, which is indicated by solid lines. Additionally, a second system partition 306(2) of the first machine 304(1), a second system partition 308(2) of the second machine 304(2), and a second system partition 310(2) of the third machine 304(3) may include standby system partitions, which is indicated by dashed lines.

In the example of FIG. 3, a system(s) (e.g., the system(s) 102) may update the cluster of machines 302 using one or more of the processes described herein. However, while the machines 304(1)-(2) may update correctly, the update for the third machine 304(3) may fail. As such, the cluster of machines 302 may perform one or more processes.

For a first example, and as shown by the upper-right illustration, the second system partition 306(2) of the first machine 304(1), the second system partition 308(2) of the second machine 304(2), and the first system partition 310(1) of the third machine 304(3) may include active system partitions, which is indicated by solid lines. Additionally, the first system partition 306(1) of the first machine 304(1), the first system partition 308(1) of the second machine 304(2), and the second system partition 310(2) of the third machine 304(3) may include standby system partitions, which is indicated by dashed lines. This is because the third machine 304(3) is still able to operate using the first system partition 310(1) even through the update failed. In some examples, the third machine 304(3) may continue to use the first system partition 310(1) until the third machine 304(3) is successfully updated.

For a second example, and as shown by the lower-left illustration, the second system partition 306(2) of the first machine 304(1) and the second system partition 308(2) of the second machine 304(2) may include active system partitions, which is indicated by solid lines. Additionally, the first system partition 306(1) of the first machine 304(1) and the first system partition 308(1) of the second machine 304(2) may include standby system partitions, which is indicated by dashed lines. Furthermore, the third machine 304(3) may be removed from the cluster of machines 302, which is also indicated by dashed lines. In some examples, the third machine 304(3) may be added back to the cluster of machines 302 when the third machine 304(3) is successfully updated.

For a third example, and as shown by the lower-right illustration, the first system partition 306(1) of the first machine 304(1), the first system partition 308(1) of the second machine 304(2), and the first system partition 310(1) of the third machine 304(3) may continue to include active system partitions, which is indicated by solid lines. Additionally, the second system partition 306(2) of the first machine 304(1), the second system partition 308(2) of the second machine 304(2), and the second system partition 310(2) of the third machine 304(3) may include one or more standby system partitions, as indicated by dashed lines. In some examples, the machines 304 may continue to use the second system partitions until the update to third machine 304(3) is successful.

In any of the examples of FIG. 3, the cluster of machines 302 may still be accessed by users and/or other devices even when the update for the third machine 304(3) fails. This provides improvements over conventional system clusters, which may be inaccessible until all of the machines are successfully updated.

Referring back to the example of FIG. 1, the machine 106(1) may include a processing unit(s) 134 and memory 136 and the machine 106(2) may include a processing unit(s) 138 an memory 140.

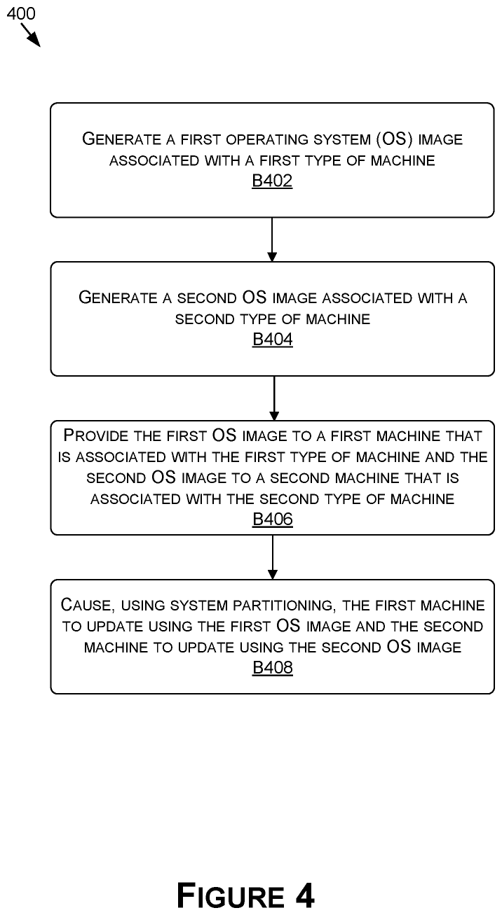

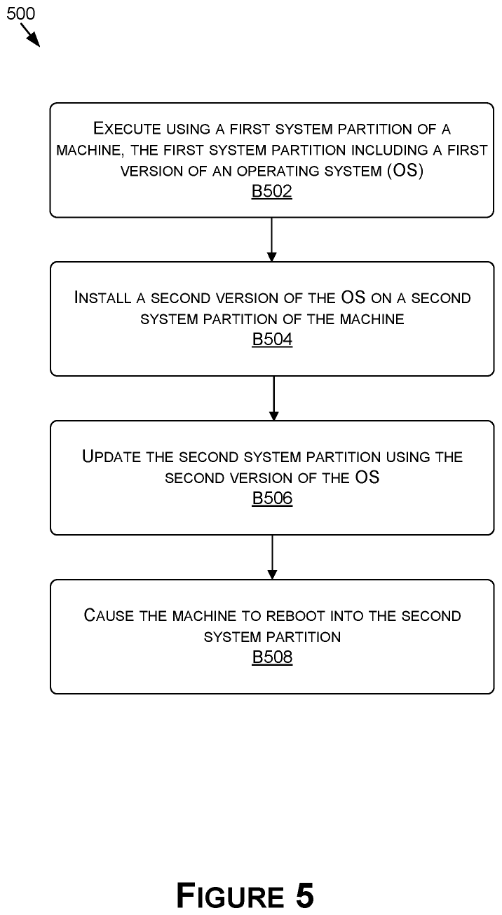

Now referring to FIGS. 4 and 5, each block of methods 400 and 500, described herein, comprises a computing process that may be performed using any combination of hardware, firmware, and/or software. For instance, various functions may be carried out by a processor executing instructions stored in memory. The methods 400 and 500 may also be embodied as computer-usable instructions stored on computer storage media. The methods 400 and 500 may be provided by a standalone application, a service or hosted service (standalone or in combination with another hosted service), or a plug-in to another product, to name a few. In addition, methods 400 and 500 are described, by way of example, with respect to the system of FIG. 1. However, the methods 400 and 500 may additionally or alternatively be executed by any one system, or any combination of systems, including, but not limited to, those described herein.

FIG. 4 is a flow diagram showing a method 400 for updating a cluster of machines using system partitioning, in accordance with some embodiments of the present disclosure. The method 400, at block B402, may include generating a first operating system (OS) image associated with a first type of machine and at block B404, may include generating a second OS image associated with a second type of machine. For instance, the system(s) 102 may generate the OS image 104(1) associated with the first type of machine and the OS image 104(M) associated with the second type of machine. For example, the OS image 104(1) may be generated based on the hardware, the software, the required tasks, and/or the like associated with the first type of machine. Additionally, the OS image 104(M) may be generated based on the hardware, the software, the required tasks, and/or the like associated with the second type of machine.

The method 400, at block B406, may include providing the first OS image to a first machine that is associated with the first type of machine and the second OS image to a second machine that is associated with the second type of machine. For instance, the system(s) 102 may provide the OS image 104(1) to the machine 106(1) and the OS image 104(M) to the machine 106(N). In some examples, to provide the OS images 104, the system(s) 102 may announce to the machines 106 (and/or a user(s) of the machines 106) that the updates are available. For example, to make the announcements, the system(s) 102 may push container images (which may be represented as “notifications 108”), which may be called “release pointers,” into a specified docker repository. The machines 106 may then discover the updates by scraping the release pointers, such as by using sidecar containers, and download the updates.

The method 400, at block B408, may include causing, using system partitioning, the first machine to update using the first OS image and the second machine to update using the second OS image. For instance, the system(s) 102 may cause the machine 106(1) to (attempt to) update using the OS image 104(1) and the machine 106(N) to (attempt to) update using the OS image 104(M). In some examples, to cause the updating, the system(s) 102 may send data to the machines 106, such as a command 124, that causes the machines 106 to begin updating the OS using the OS images 104 (e.g., triggers post install scripts in the OS images 104). As described herein, the machines 106 may update using system partitioning.

FIG. 5 is a flow diagram showing a method 500 for updating a machine using system partitioning, in accordance with some embodiments of the present disclosure. The method 500, at block B502, may include executing using a first system partition of a machine, the first system partition including a first version of an operating system (OS). For instance, the machine 106(1) may be executing using the first system partition 110(1) that includes the first version of the OS 112(1) and/or the configuration(s) 120. As described herein, the configuration(s) 120 may include, but is not limited to, the graphics configurations, the dynamic configurations, the network configurations, time configurations, and/or any other configuration. Additionally, such as when the machine 106(1) is included within a cluster of machines, the configuration(s) 120 may include, but is not limited to, configurations indicating the locations of the machines 106 included in the cluster, configurations indicating how to connect with the machines 106 included in the cluster, configurations indicating the types of the machines 106 in the cluster, and/or the like.

The method 500, at block B504, may include installing a second version of the OS on a second system partition of the machine. For instance, the machine 106(1) may install the OS image 104(1) associated with the second version of the OS on the second system partition 110(2). In some examples, to perform the installation, a component (e.g., an Elastic Fabric Adapter (EFA)) running on the machine 106(1) may monitor for objects, such as by using an API (e.g., an EMS API). Based on the monitoring, the machine 106(1) may discover the desired version of the OS (e.g., the OS image 104(1)) as well as instructions on how to perform the update (e.g., which OTA runner image to use, what are the command line arguments and/or environment variables to pass when launching the containers, etc.). The machine 106(1) may then download and install the OS image 104(1).

The method 400, at block B506, may include updating the second system partition using the second version of the OS. For instance, the machine 106(1) may (attempt to) update the second system partition 110(1) using the OS image 104(1) that is installed in the second system partition 110(2). In some examples, to attempt to perform the update, the OS 112(1) that is running on the first system partition 110(1) may trigger a post install script on the second system partition 110(2), where the post install script causes the updating of the OS. In some examples, the updating of the OS may be initiated by the system(s) 102. For example, the system(s) 102 may send data to the machine 106(1), such as a command 124, that causes the machine 106(1) to begin updating the OS using the OS image 104(1) (e.g., triggers the post install script).

The method 400, at block B508, may include causing the machine to reboot into the second system partition. For instance, after performing the update, the machine 106(1) may reboot using the second system partition 110(2). If the reboot is successful (e.g., the machine 106(1) was successfully updated), then the machine 106(1) may continue to boot using the second system partition 110(2).

Example Computing Device

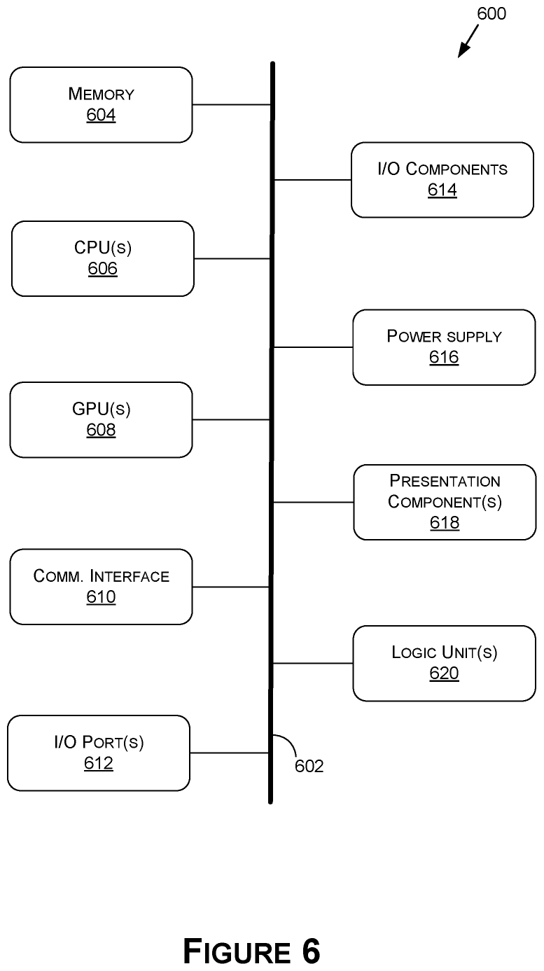

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

Example Data Center

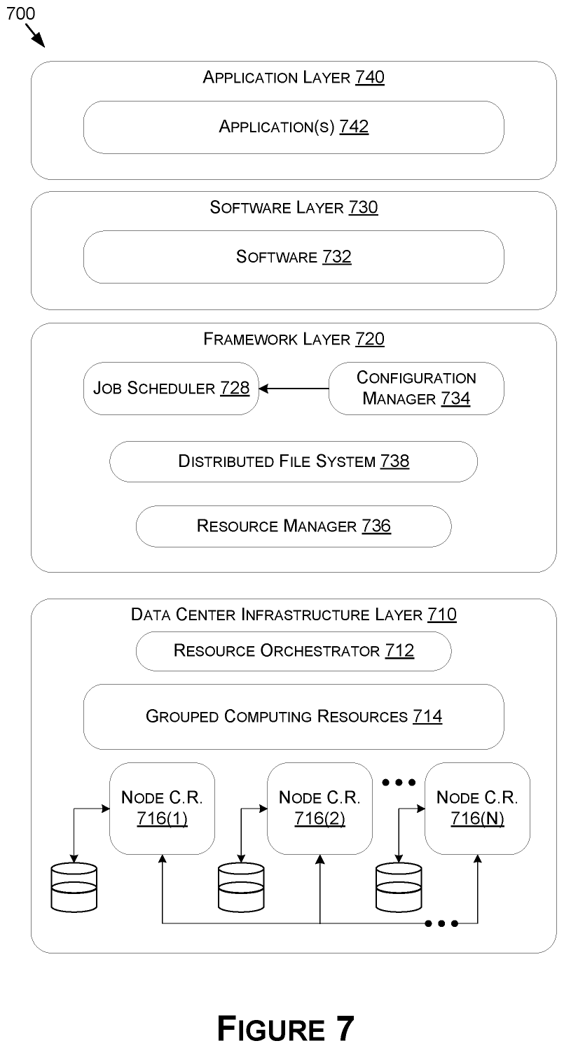

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
generating a first operating system (OS) image associated with a first type of machine, the first OS image including a first root file system;
generating a second OS image associated with a second type of machine, the second OS image including a second root file system;
providing the first OS image to a first machine and the second OS image to a second machine, the first machine being associated with the first type of machine and the second machine being associated with the second type of machine; and
causing, using system partitioning, the first machine to update using the first OS image and the second machine to update using the second OS image.

2. The method of claim 1, wherein:
the first machine and the second machine are included in a cluster of machines; and
the causing of the first machine to update using the first image occurs within a threshold period of time from the causing the second machine to update using the second image.

3. The method of claim 1, wherein:
the providing the first OS image to the first machine comprises storing the first OS image on a datastore accessible to the first machine; and
the providing the second OS image to the second machine comprises storing the second OS image on the datastore accessible to the second machine.

4. The method of claim 1, wherein the causing, using system partitioning, the first machine to update using the first OS image and the second machine to update using the second OS image comprises:
sending, to the first machine, first data that causes the first machine to update a first standby system partition using the first OS image; and
sending, to the second machine, second data that causes the second machine to update a second standby system partition using the second OS image.

5. The method of claim 1, further comprising:
generating a first cryptographic key;
embedding the first cryptographic key in the first OS image;
generating a second cryptographic key;
embedding the second cryptographic key in the second OS image.

6. The method of claim 5, further comprising:
verifying, using the first cryptographic key, at least one of a first OS or the first root file system updated on the first machine based at least on one or more first hashes received from the first machine; and
verifying, using the second cryptographic key, at least one of a second OS or the second root file system updated on the second machine based at least on one or more second hashes received from the second machine.

7. The method of claim 5, wherein:
the first cryptographic key is associated with a first time window for verifying the update associated with the first OS image; and
the second cryptographic key is associated with a second time window for verifying the update associated with the second OS image.

8. The method of claim 1, further comprising:
receiving an indication that the update using the first OS image failed on the first machine; and
based at least on receiving the indication:
initiate another attempt to provide the first OS image to the first machine; and
initiate another attempt to cause the first machine to be updated using the first OS image.

9. A machine comprising:
one or more processing units to:
execute using a first system partition of the machine, the first system partition including a first version of an operating system (OS);
install an OS image associated with a second version of the OS on a second system partition of the machine;
update, using the OS image, the second system partition to the second version of the OS; and
cause the machine to reboot into the second system partition based at least on the second system partition being updated.

10. The machine of claim 9, wherein the machine is one machine of a cluster of machines, and wherein the one or more processing units are further to:
generate, using the first system partition, a copy of one or more configurations associated with the cluster of machines; and
store the copy of the one or more configurations in the second system partition.

11. The machine of claim 9, wherein the one or more processing units are further to:
determine that an error occurred with at least one of the second system partition being updated or the reboot into the second system partition; and
cause, based at least on a determination that an error occurred, cause the machine to reboot into the first system partition.

12. The machine of claim 11, wherein the one or more processing units are further to:
attempt to install the OS image associated with the second version of the OS on the second system partition of the machine;
attempt to update, using the OS image, the second system partition to the second version of the OS; and
based at least on the second system partition again being updated, cause the machine to again reboot into the second system partition.

13. The machine of claim 9, wherein the one or more processing units are further to:
generate, based at least on the second system partition being updated, a hash associated with the second version of the OS; and
verify the second version of the OS based at least on the hash and a cryptographic key embedded within the OS image.

14. The machine of claim 13, wherein the verification of the second version of the OS comprises at least one of:
sending, to a system that verifies the second version of the OS, the hash and the cryptographic key; or
sending, to the system, the hash signed using the cryptographic key.

15. The machine of claim 9, wherein the one or more processing units are further to receive data that causes the second system partition to be updated using the SO image.

16. The machine of claim 15, wherein the data represents a container that triggers a post install script associated with the OS image, the post install script causing one or more steps associated with the second system partition being updated using system partitioning.

17. The machine of claim 9, wherein the one or more processing units are further to:
receive, from a system, an indication that the OS image is available for updating the machine; and
based at least on the indication, receive the OS image from a datastore associated with the system.

18. The machine of claim 9, wherein the machine is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating at least one of virtual reality (VR) content, augmented reality (AR) content, or mixed reality (MR) content;
a system for presenting at least one of VR content, AR content, or MR content;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

19. A processor comprising:
one or more processing units to cause, using system partitioning, a first machine to update using a first operating system (OS) image and a second machine to update using a second OS image, the first machine and the second machine being associated with a cluster of machines.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating at least one of virtual reality (VR) content, augmented reality (AR) content, or mixed reality (MR) content;
a system for presenting at least one of VR content, AR content, or MR content;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
